(19) United States
(12) Patent Application Publication
(10) Pub. No.: US 2009/0282356 A1
(43) Pub. Date: Nov. 12, 2009

(54) SYSTEM AND METHOD FOR VISUALLY REPRESENTING TIME-BASED DATA

(76) Inventors: Adam H. Rofer, Los Gatos, CA (US); Shashi Shekar Madappa, Sunnyvale, CA (US); Klaus ten-Hagen, Goeilitz (DE)

Correspondence Address: CHRISTIE, PARKER & HALE, LLP, PO BOX 7068, PASADENA, CA, 91109-7068, US

(21) Appl. No.: 12/436,029

(22) Filed: May 5, 2009

Related U.S. Application Data
(60) Provisional application No. 61/051,176, filed on May 7, 2008.

(51) Int. Cl. G06F 3/048

(52) U.S. Cl. 715/771; 715/777; 707/104.1

(57) ABSTRACT

A method performed by one or more computers for processing and displaying time-based data. The method includes storing manufacturing information including information about items, tests, test stations, and results of tests, in a database; sorting the stored manufacturing information in chronological order; tabulating a distance matrix with the sorted information, the distance matrix indexed by one or more of said items, said different tests, and said test stations; and displaying on a display monitor the distance matrix as a graph comprising of a plurality of test steps depicted as a series of diagram nodes and including tests or test stations, test transitions between each test step depicted as a series of arrows and including values for respective test transitions, test step descriptions corresponding to each respective test step, and test results corresponding to said each respective test step.

### CROSS-REFERENCE TO RELATED APPLICATION

This patent application claims the benefit of the filing date of U.S. Provisional Patent Application Ser. No. 61/051,176, filed May 7, 2008 and entitled “System And Method For Visually Representing Time-Based Data”, the entire content of which is hereby expressly incorporated by reference.

### FIELD OF THE INVENTION

This invention relates to the general area of computer aided manufacturing, and more specifically to a system and method for visually representing time-based data.

### BACKGROUND

In a product data management environment, process comprehension is crucial. Businesses in high-tech manufacturing environments need to be able to understand the data generated by the process environment including different processes in order to ensure supplier quality and in-process quality.

In a typical manufacturing environment, data is generated by test/repair/assembly stations and then logged for information retrieval. This data is then typically displayed in a tabular or chart format (histogram, pareto charts, etc). The problem with this visualization is that it cannot provide an accurate representation of the real flow of the manufacturing process. The more comprehensive flow analysis tools typically only use conventional statistical process tools to calculate values, which can be complex and confusing.

Therefore, there is a need for an improved system and method for generating and comprehensively displaying relevant manufacturing data to make decisions and investigations related to manufacturing process easier.

### SUMMARY

In some embodiments, the present invention is a method performed by one or more computers for processing and displaying time-based data. The method includes storing manufacturing information including information about items, tests, test stations, and results of tests, in a database; sorting the stored manufacturing information in chronological order; tabulating a distance matrix with the sorted information, the distance matrix indexed by one or more of said items, said different tests, and said test stations; and displaying on a display monitor the distance matrix as a graph comprising of a plurality of test steps depicted as a series of diagram nodes and including tests or test stations, test transitions between each test step depicted as a series of arrows and including values for respective test transitions, test step descriptions corresponding to each respective test step, and test results corresponding to said each respective test step.

The values for respective test transitions may include one or more of: count of test steps having a certain test result, count of all test steps, count of items with said certain test result, count of all items, and percentage of items having said certain test result relative to items not having said certain test result. Additionally, values for respective test transition may include one or more of a first-pass-yield indicating a first test result of an item at a test step, and time between tests.

### BRIEF DESCRIPTION OF THE DRAWINGS

FIG. 1 shows an exemplary process, according to some embodiments of the present invention.

FIG. 1A shows a block diagram of a typical client server environment used by the users of the present invention to store, process, transmit and display information, according to some embodiments of the present invention.

FIG. 2 illustrates an exemplary distance matrix tabulation process performed by one or more computers, according to some embodiments of the present invention.

FIG. 3 shows a visualization example, according to some embodiments of the present invention.

FIG. 4 shows a visualization example, after one UNIQUE_DEVICE data has been populated in a distance matrix, according to some embodiments of the present invention.

FIG. 5 depicts the visualization example of FIG. 4, after 100 UNIQUE_DEVICE data records have been populated in the distance matrix.

FIG. 6 shows a visualization example, when TEST_STEPs are TEST_STATIONs, and sorted by TEST_TEST horizontally, according to some embodiments of the present invention.

FIG. 7 shows an exemplary Test Flow for a large time range and a large list of devices, according to some embodiments of the present invention.

FIG. 8 depicts an exemplary Test Flow with the first node (test) fully displayed, according to some embodiments of the present invention.

FIG. 9 illustrates an exemplary dynamic repositioning of the nodes, according to some embodiments of the present invention.

FIG. 10 depicts an exemplary “Circle” display view, according to some embodiments of the present invention.

FIG. 11 shows an exemplary Test Flow by Station diagram, according to some embodiments of the present invention.

FIG. 12 illustrates an exemplary Test Flow by Station diagram with the first Station enabled, according to some embodiments of the present invention.

FIG. 13 shows an exemplary Test Flow by Station, only with a first station information shown, according to some embodiments of the present invention.

FIG. 14 depicts an exemplary Device Flow for a single unit, according to some embodiments of the present invention.

### DETAIL DESCRIPTION

The present invention intelligently processes captured manufacturing data and displays the processed data for the user to visualize the process flows in an intuitive manner. The process data is converted into a diagram that allows the user to easily discover elements of the process that may be aberrant and require follow-up or investigation. This shows the user various points of information in such a way that the overall process can be quickly and easily identified. It also allows an easy identification of the overall process flow, items that have an aberrant flow (for example, items returned to a previous step in the manufacturing process, items skipping a crucial step, items cycling at a specific step, etc), potentially faulty devices, and/or utilization of the manufacturing environment, throughput, and equipment. Data here represents physical data, such as data about items being tested, the physical test stations (including test results), repair stations (including the repairs performed on the item), etc. The physical data is then transformed to visual data to represent and visualize the transformed physical data in a more intuitive manner.

Table 1 includes a glossary of the terminology used for processing and displaying manufacturing data.

TABLE 1
PRODUCT: typically refers to a single item or a series of items tested, manufactured and/or
repaired.
START_TRANSITION: is indication of a first instance of a UNIQUE_DEVICE starting
anywhere, typically drawn as a arrow from the “start” to the location having the first instance.
TEST_RETEST: is where the same TEST_TEST occurs in a row. For example, an item tested at
station 1, FAIL; tested at station 2, PASS; etc. This basically represents a TEST_TRANSITION
that points to the originating TEST_TEST.
TEST_STEP: is shown as a diagram node, typically a Test, Station, or Test Type and is used to
indicate a conceptual step in the process to visualize.
TEST_TRANSITION: typically drawn as an arrow, connects two TEST_STEPs to indicate at
least one instance of a UNIQUE_DEVICE first existing at one TEST_STEP and then existing at
the other TEST_STEP.
TEST_TRANSITION_ARROW: indicates the direction of flow of the TEST_TRANSITION.
TEST_TRANSITION_VALUE: indicates the weight of the flow of the TEST_TRANSITION.
TEST_WORK_IN_PROGRESS: is the last instance known in the context for the
UNIQUE_DEVICE, existing at a specific TEST_STEP.
TEST_TEST: is a type of TEST_STEP typically referring to a Test where the result can be
TEST_PASS, TEST_FAIL, or other. TEST_TEST can also represent a repair, an assembly of a
device, a return of goods (RMA), a shipping of an item, or other such stages of an item during its
lifecycle.
TEST_PASS: is an instance where a UNIQUE_DEVICE was tested and passed the criteria of the
TEST_TEST.
TEST_FAIL: is an instance where a UNIQUE_DEVICE was tested and failed the criteria of the
TEST_TEST.
UNIQUE_DEVICE: typically refers to a single item tested, manufactured and/or repaired.

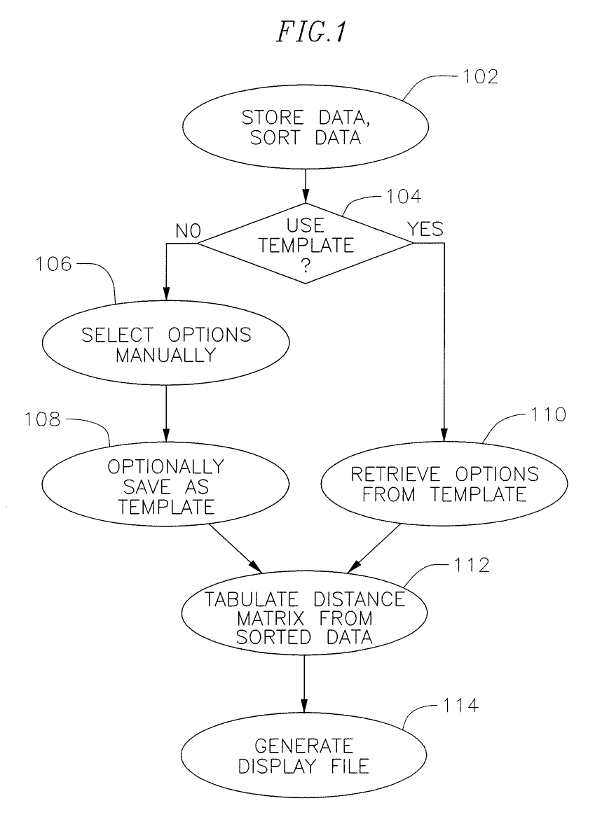

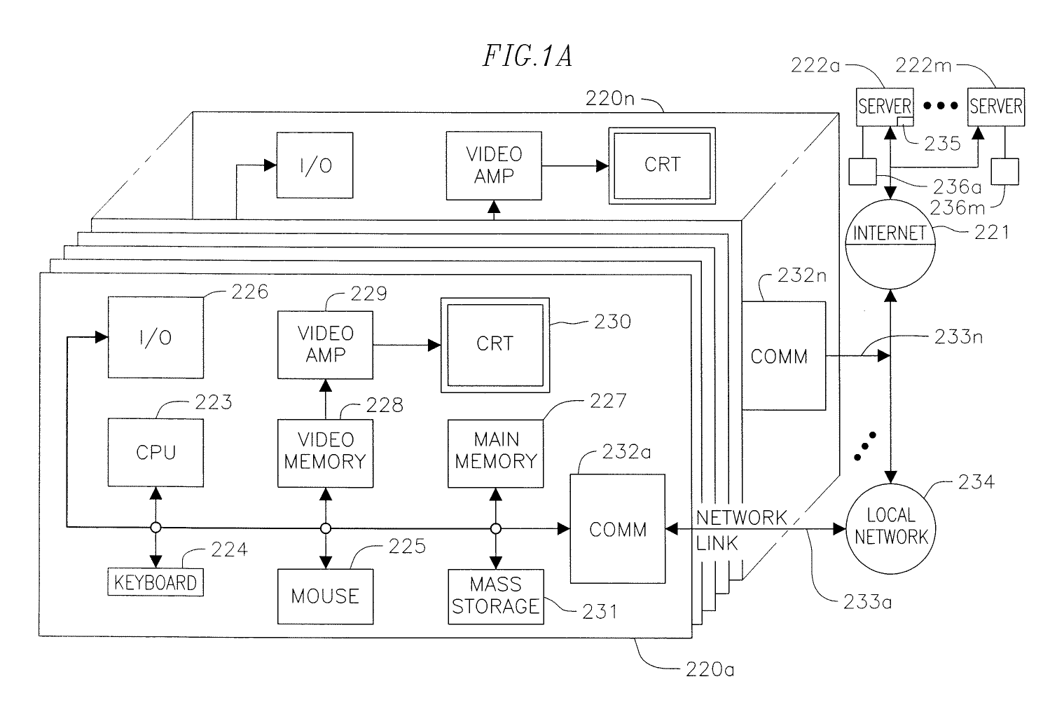

FIG. 1 shows an exemplary process performed by one or more computers, according to some embodiments of the present invention. In block 102, the manufacturing test process data is stored in a database and then chronologically sorted for processing by UNIQUE_DEVICE (that is, a single item being tested or manufactured) and by time. In some embodiments, the manufacturing test process data include information about items (being) tested and/or (being) manufactured. It also includes information about different tests, test stations, criteria used for testing, and results of any test that is completed, such as pass or fail and more specific information about where and how an item failed a particular test. The sorted data additionally includes information about repairs to the items, such as repairs to the items, return merchandise authorization (RMA) and shipping history information, genealogy information, and other information about the UNIQUE_DEVICE or the function/results performed on the UNIQUE_DEVICE.

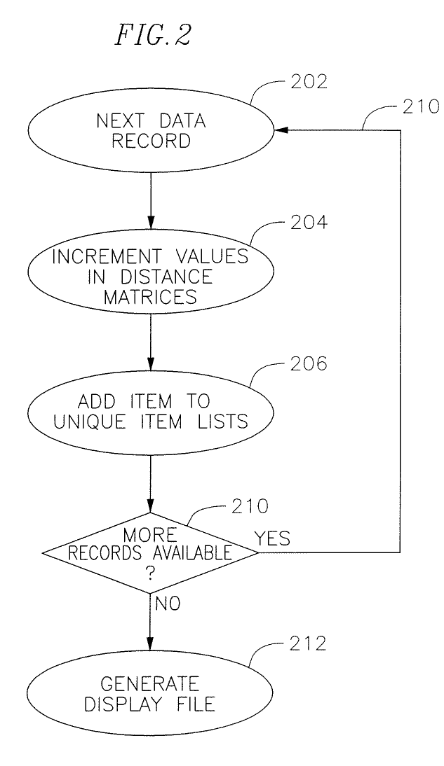

As shown, in block 104, the user can decide to use a previous set of options (“Template”), or manually set the option. In block 106, the options for display are set. This can include the order of data. For example, the user may select to sort by “test X,” then “test Y,” then “test W.” This is usually done according to how the optimal flow of the data mostly operates. After this, the user may store the options as a Template to be used again, as shown in block 108. In block 110, the user selects a template for retrieval and the preset options are then used instead of manually setting them. A distance matrix is then tabulated (for example, row by row) from the sorted data (for example, indexed by tests, test stations, tests with test stations, or by test types, as set by the user), in block 112. This directly translates to the viewable information as the distances tabulated are displayed as TEST_TRANSITION_VALUEs. More detail of this process is depicted in FIG. 2 and is discussed below. A display file is then generated including the distance matrix and the order of data to be displayed to the user, in block 114. In some embodiments, the display file is in the form of a directed weighted graph.

A distance matrix generally refers to a matrix (a two-dimensional array) containing the distances, taken pairwise, of a set of points. It may be a symmetric N×N matrix containing non-negative real numbers as elements, given N points in Euclidean space. The number of pairs of points N×(N−1)/2 is the number of independent elements in the distance matrix. Distance matrices are closely related to adjacency matrices, with the difference that the latter only provides the information which vertices are connected but does not tell about costs or distances between the vertices.

FIG. 1A shows a block diagram of a typical client server environment used by the users of the present invention to store, process, transmit and display information, according to some embodiments of the present invention. Computers, for example, PCs 220a-220n are connected to a computer network, for example, the Internet 221 through the communication links 233a-233n. Optionally, a local network 234 may serve as the connection between some of the PCs 220a-220n, such as the PC 220a and the Internet 221. Servers 222a-222m are also connected to the Internet 221 through respective communication links. Servers 222a-222m include information and databases accessible by PCs 220a-220n. In some embodiments of the present invention, one or more databases reside on one or more of the servers 222a-222m and are accessible by the users of the present invention using one or more of the PCs 220a-220n.

In some embodiments of the present invention, each of the PCs 220a-220n typically includes a central processing unit (CPU) 223 for processing and managing data, and a keyboard 224 and a mouse 225 for inputting data. Also included in a typical PC, are a main memory 227, such as a Random Access Memory (RAM), a video memory 228 for storing image data, and a mass storage device 231 such as a hard disk for storing data and programs. Video data from the video memory 228 is displayed on a display monitor, such as a CRT 230 by the video amplifier 229 under the control of the CPU 223. A communication device 232, such as a network interface or a modem, provides access to the Internet 221. An Input/Output (I/O) device 226 reads data from various data sources and outputs data to various data destinations, within each PC.

Servers (hosts) 222a-222m typically have architecture similar to the architecture of PCs 220a-220n. Generally, servers differ from the PCs in that servers can handle multiple telecommunication connections at one time. Some server (host) systems may actually be several computers linked together, with each handling incoming web page requests. In some embodiments, each server 222a-222m has a storage medium 236a-236m, such as a hard disk, a CD drive or a DVD for loading computer software, back up tapes, and the like. When software such as that responsible for executing the processes in FIGS. 1 and 2 is loaded on the server 222a, off-the-shelf web management software or load-balancing software may distribute the different modules of the software to different servers 222a-222m. Alternative or in addition to the servers, the software may reside on one or more of the PCs.

An exemplary web site location 235 is also shown on server 222a in FIG. 1A. In some embodiments, the web site 235 may be the user interface (UI) for accessing the databases and processing and displaying information, according to some embodiments of the present invention. In some embodiments, the computer software for executing the processes of the present invention may also reside within the web site 235.

FIG. 2 illustrates an exemplary distance matrix tabulation process performed by one or more computers, according to some embodiments of the present invention. As shown in block 202, a data record is retrieved from a database. The data record is typically a list of chronological values representing physical entities or events, such as “A device with part number ‘XYZ’ and serial number ‘123’ has passed through test ‘ABC,’ at the test station ‘UVW’ with the outcome of ‘FAIL’ on ‘01/01/2008’ at ‘12:05:36 PM.’

In block 204, the values in the distance matrix are incremented to reflect the passing of a UNIQUE_DEVICE or another test instance, for example, a TEST_TEST through the respective TEST_TRANSITION. In some embodiments, TEST_TEST may include a variety of different data points related to different stages of an item during its lifecycle. For example, it can represent a repair, an assembly of a device, a return of goods (RMA), a shipping of an item, and the like.

In block 206, an item, such as an instance of a UNIQUE_DEVICE or PRODUCT is added to a list to be provided later as additional information. In block 208, if there are more data records available, the process goes back (210) to block 202, and retrieves the next data record in block 202. If there is no more data records, a display file is then generated in block 212.

In some embodiments, data is retrieved based on a specific set of criteria to be selected by the user via a setup screen or a template as described above. For example, an SQL database query might be restricted to one serial number of an item, or one (test or repair) station. Alternatively, the query may not be restricted at all and therefore display all the data. For instance, a database query is generated based on specific filtering criteria and/or configuration items for PFV (which items to show/hide, what font, etc), selected by the user.

For example, in some embodiments, the data may look like:

| SN | PROD | TEST | DATE/TIME | OUTCOME |
|---|---|---|---|---|
| 123 | ABC | TEST1 | 1/1/1 00:00:01 | PASS |
| 123 | ABC | TEST2 | 1/1/1 00:00:02 | FAIL |
| 123 | ABC | TEST2 | 1/1/1 00:00:03 | PASS |
| 123 | ABC | TEST3 | 1/1/1 00:00:04 | PASS |
| 124 | ABC | TEST1 | 1/1/1 00:00:02 | PASS |

Here, one UNIQUE_DEVICE was tested at TEST1 and passed, TEST2 and failed, RETESTED at TEST2 and passed; and finally tested at TEST3 and passed. Another UNIQUE_DEVICE was tested at TEST1 and passed.

As another example, consider:

START---2→(TEST1 (1/0))---1→(TEST2 (0/0))(*0/1)---1→(TEST3 (1/0))

That is, two items went into TEST1, one remained there after passing, and one passed to TEST2, where (*0/1) means one item was re-tested after failing. The one item then passes out to TEST3, where it remains there after passing. Since the data is sorted chronologically based on each UNIQUE_DEVICE, the invention considers each UNIQUE_DEVICE's actions over time, that is, tested at station 1, PASS; tested at station 2, FAIL; etc.

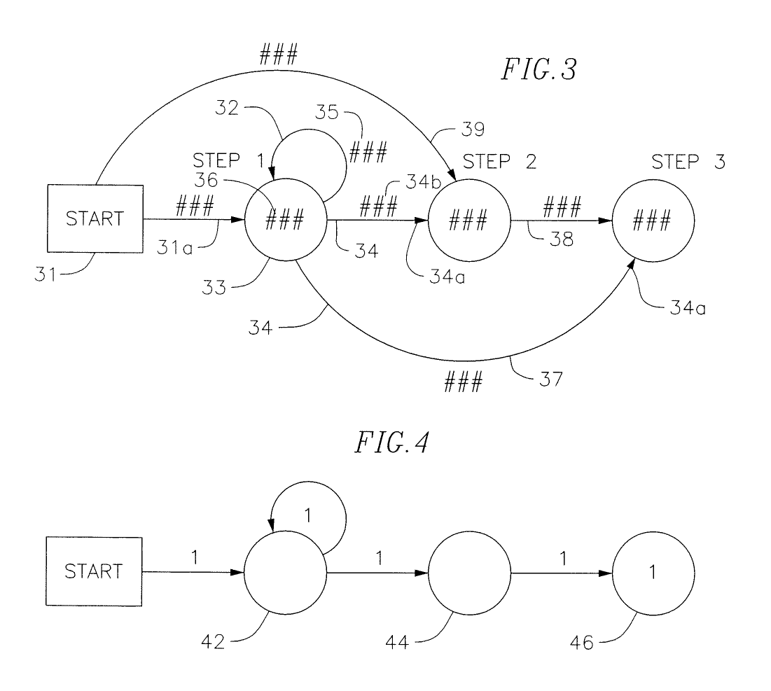

FIG. 3 shows a visualization example after processing the range of data initially selected by the user, such as: restricting the data to a time range, UNIQUE_DEVICE list, PRODUCT, or other parametric data stored in the database. The visualization example is displayed on one or more display monitors. As shown by block 31, the start location START_TRANSITIONs connecting here to a TEST_STEP typically represent the amount of first instances of each UNIQUE_DEVICE at that TEST_STEP. Where “###” is displayed, a number or percentage will be displayed indicating the TEST_TRANSITION_VALUE (e.g., see 34b). The UNIQUE_DEVICE typically refers to a single item tested, manufactured and/or repaired. The TEST_STEP shown as a diagram node here may typically be a test station or test type used to indicate a conceptual step in the process to visualize. For example, it may represent a test containing all information related to that single test type, or it may just represent a single physical test station, conceptually showing the devices flowing in and out of the station as they are tested.

START_TRANSITION 31a is a special type of TEST_TRANSITION (see, 3.1 and 34). TEST_STEP title 32 describes the TEST_STEP and can be TEST_NAME, TEST_TYPE, TEST_STATION, or anything describing the specific TEST_STEP. TEST_STEP 33 represents a TEST_TEST, TEST_TYPE, or TEST_STATION (or others).

TEST_TRANSITION 34 represents one or more UNIQUE_DEVICEs passing from one TEST_STEP to another. TEST_TRANSITION is only present if at least one UNIQUE_DEVICE has data at TEST_STEP and then its next record shows data at the connecting TEST_STEP. TEST_TRANSITION_ARROW 34a indicating the TEST_TRANSITION direction, and TEST_TRANSITION_VALUE 34b (represented by “###”) represents the value of the TEST_TRANSITION. Depending on the user's intentions, this can include, but is not restricted to, any of the following numeric values (referring to the transition from one TEST_STEP to another TEST_STEP):
count of TEST_TESTs having a TEST_PASS/TEST_FAIL
count of all TEST_TESTs
count of UNIQUE_DEVICEs having a TEST_PASS/TEST_FAIL
count of all UNIQUE_DEVICEs
percentage TEST_PASS/TEST_FAIL/overall divided by TEST_STEP/UNIQUE_DEVICE TEST_TEST throughput
percentage TEST_PASS/TEST_FAIL/overall divided by overall TEST_TEST/UNIQUE_DEVICE count

TEST_TRANSITION_VALUE 35 (represented by “###”) for a TEST_RETEST can represent any of the values described for 34b, where the first TEST_STEP of the TEST_TRANSITION is equal to the connecting TEST_STEP. TEST_WORK_IN_PROGRESS 36 (represented by “###”) typically represents the amount of last instances of each UNIQUE_DEVICE at that TEST_STEP (see 31) for first instances. This may also display separate values for TEST_PASS and TEST_FAIL as the last result from the TEST_STEP.

TEST_TRANSITION 37 that indicates one or more UNIQUE_DEVICEs following an aberrant flow. This is because this/these UNIQUE_DEVICE(s) did not operate at the TEST_STEP “STEP 2” before continuing to the TEST_STEP “STEP 3.” TEST_TRANSITION 38 may indicate one or more UNIQUE_DEVICEs following an aberrant flow. This is because this/these UNIQUE_DEVICE(s) operated at the TEST_STEP “STEP 3” and then operated at the TEST_STEP “STEP 2.” TEST_TRANSITION 39 may indicate one or more UNIQUE_DEVICEs following an aberrant flow. This is because this/these UNIQUE_DEVICE(s) first operated at the TEST_STEP “STEP 2,” effectively skipping the TEST_STEP “STEP 1.”

FIG. 4 shows a visualization example, after one UNIQUE_DEVICE data has been populated in the distance matrix, according to some embodiments of the present invention. The UNIQUE_DEVICE is first operated upon (tested, programmed, manufactured, repaired, etc. . . . ) at a TEST_STEP, in block 42. Each of the “1”s pictured represent the value of the TEST_TRANSITION, showing in this instance that “one device has passed along this path.” From this information, it can be seen and easily understood that one UNIQUE_DEVICE has passed through these three test steps. In block 44, the UNIQUE_DEVICE is operated again at the TEST_STEP and then operated for the third time at the TEST_STEP, in block 46. The distance matrix for the values (count of all UNIQUE_DEVICEs or all TEST_TESTs (see, e.g., 3.4b in FIG. 3) would be: [[1, 1, 0][0, 0, 1][0, 0, 0]], the start distance matrix would be: [1, 0, 0], and the end distance matrix would be: [0, 0, 1]

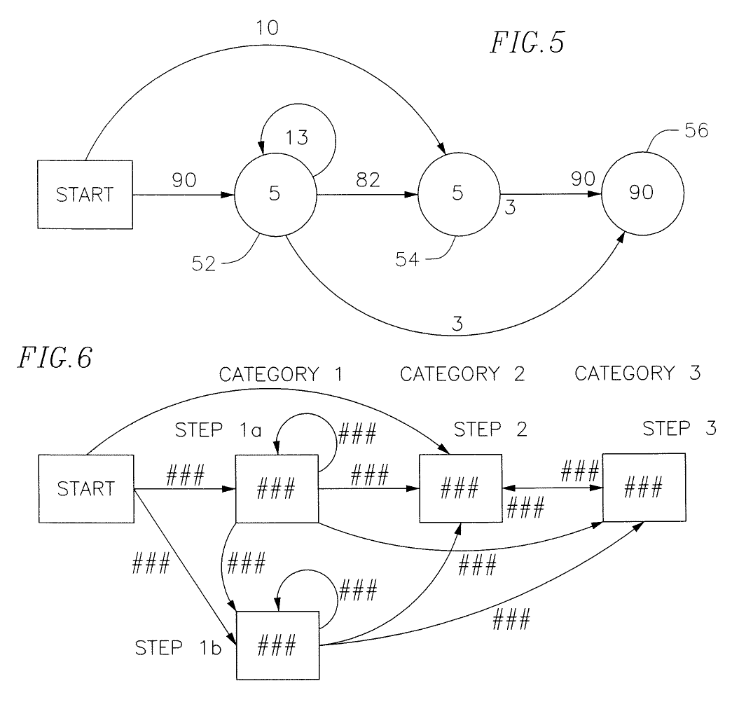

FIG. 5 depicts the visualization example of FIG. 4, after 100 UNIQUE_DEVICE data records have been populated in the distance matrix. The exemplary distance matrix for the values (count of all UNIQUE_DEVICEs or all TEST_TESTs (see 3.4b in FIG. 3) would be: [[13, 82, 3][0, 0, 90][0, 3, 0]], the start matrix would be: [90, 10, 0], and the end distance matrix would be: [5, 5, 90]. This data is calculated and the values are placed on the visualization graph. These numbers represent the count of devices transferred from one location/test/station to another. As explained above, a distance matrix is the tabulation of data between locations. For example, if one has two tests called TEST_1 and TEST_2, and 5 devices have first been tested at TEST_1 that passed and then were tested at TEST_2, this would correspond to a 5 in the “passed” distance matrix for two tests: [0, 5] [0, 0] (0 went from TEST_1 to TEST_1, 5 went from TEST_1 to TEST_2, 0 went from TEST_2 to TEST_1, 0 went from TEST_2 to TEST_2)

These numbers, once calculated, are placed on the visualization graph at the locations they correspond to. The graph generated from [0, 5] [0, 0] (with start matrix of [5, 0]—5 started at TEST_1, and end distance matrix of [0, 5]—5 ended at TEST_2) would look like: Start→5→(test1)→5→(test2 [5]).

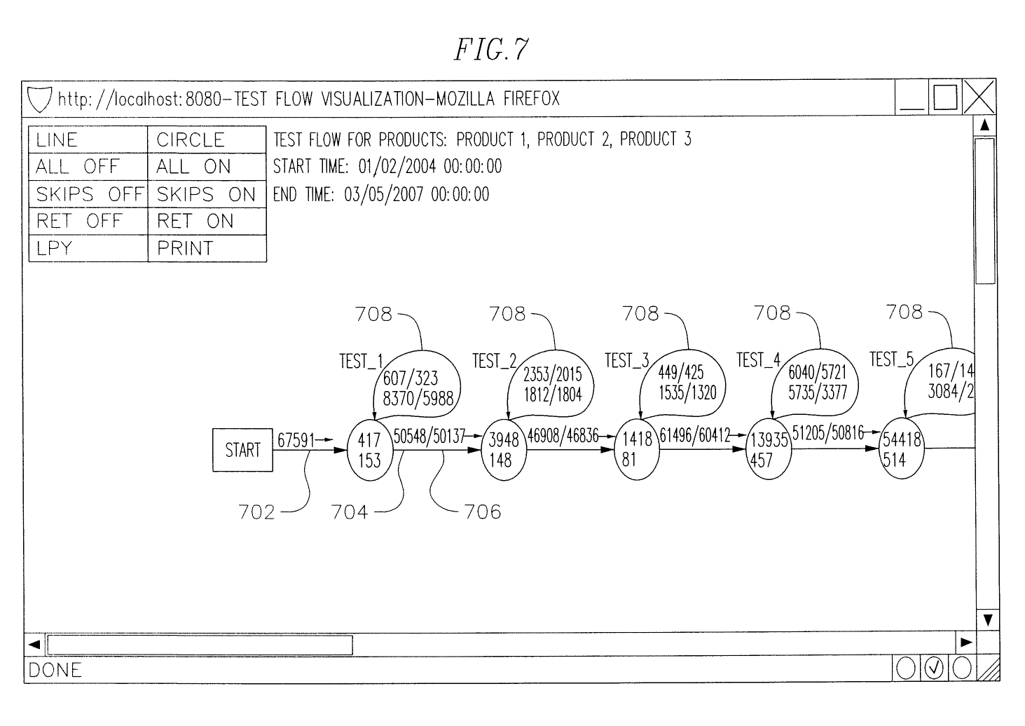

A user visually inspecting this exemplary graph would note that 5 devices went from TEST_1 to TEST_2 without any special cases. What the user would be looking for is aberrant flows, or devices skipping tests, or devices being retested after passing. There are many different cases in which this can work, such as actual devices passing through actual test stations, as in FIG. 6.

The numbers (“TEST_TRANSITION_VALUE”) on the arrows (as set by user options) may include one or more of the following:
Actual device count (one device transitioning along the same path twice is counted as one only)
Actual transition count (one device transitioning along the same path twice is counted as two)
Actual device count, as a percentage of overall device count
Actual transition count, as a percentage of transition count from that location
“First Pass Yield” indicating only the first results of a device at that location
Time between tests, indicating the min/max/average time taken along that transition
A combination of the above. Typically the Test count is shown, and if the unique device count is different (a device transitioned on the same transition more than once) then it is displayed as well. This is set by user options.
   The locations themselves (“TEST_STEP”) (as set by user options) may include one or more of the following:
Tests regardless of physical station location
Physical stations regardless of test
Physical stations ordered horizontally by test (FIG. 6)
Station Types regardless of test or physical station

FIG. 6 shows a visualization example, when TEST_STEPs are TEST_STATIONs, and sorted by TEST_TEST horizontally, according to some embodiments of the present invention. The explanation for this figure is similar to that of the explanation for FIG. 3, except for a few qualifications. Firstly, the square TEST_STEPs do not represent TEST_TESTs, they represent TEST_STATIONs in this example. Secondly, a good initial view of this visualization is to position the TEST_STEPS vertically according to TEST_TESTs (so if two TEST_STATIONs have the same TEST_TEST, they will be in the same column). A “Category 1,” for example, could represent the first TEST_TEST in the sequence selected in block 208 of FIG. 2. In this example, the steps “Step 1,” “Step 2,” and “Step 3” are physical station locations (“TEST_STATION”) and item are identical to descriptions given for the general multiple cases in FIG. 6. The categories are used in “Test Flow By Station” to show specific TEST_STATIONs organized specifically by TEST_TEST. This allows the user to visually see flow from “Test Flow” but expanded in the context of actual Test Stations. Other categories may be used, such as STATION_TYPE.

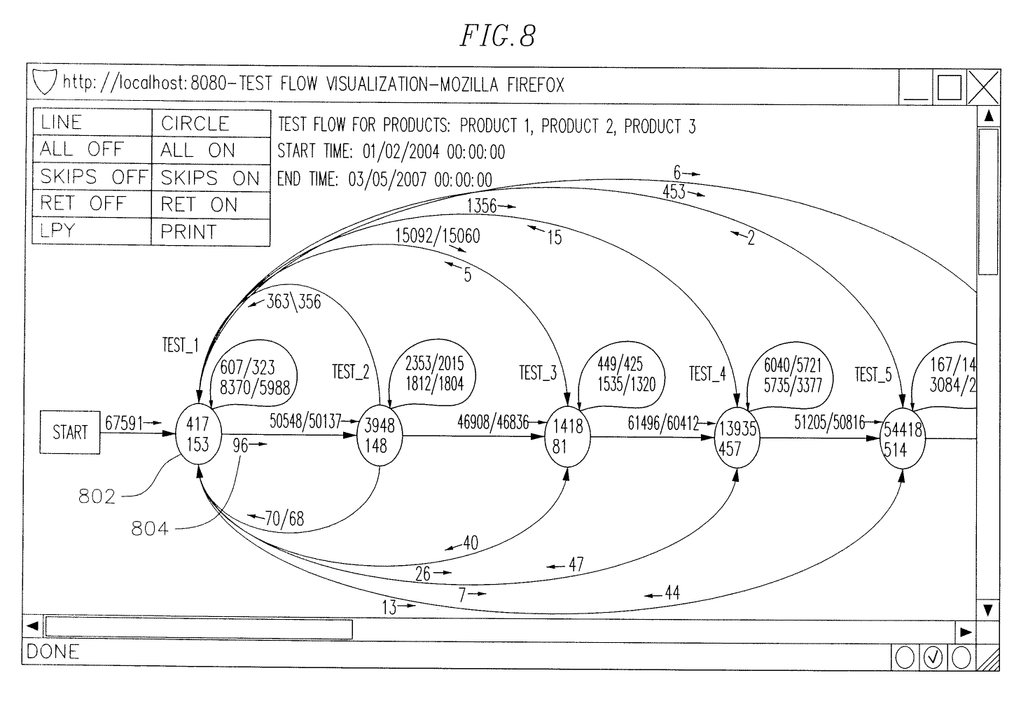

FIG. 7 shows an exemplary Test Flow for a large time range and a large list of devices, according to some embodiments of the present invention. Initially, only the “pass” results that continue to the immediate next test are displayed for convenience. The exemplary number 702 is the amount of devices starting at this TEST (e.g., 67591). The first number 704 (e.g., 50548) is the number of TESTS. The second number 706 (e.g., 50137) is the number of UNIQUE DEVICES. If these numbers differ (they only display two if they differ in this application configuration), then at least one device went along this path more than once. For example, 50548−50137=411 cases where a device has already went along this path before doing it again. The numbers inside the graph loops 708 indicate, respectively: the number of tests that passed then were tested at that test immediately again (e.g., 607), the number of unique devices that passed then were tested at that test immediately again (e.g., 323), the number of tests that passed then were tested at that test immediately again (e.g., 8370), the number of unique devices that passed then were tested at that test immediately again (e.g., 5988). Hovering a pointer device, such as a computer mouse, over the first test, and then double clicking reveals the next screenshot, shown in FIG. 8.

The exemplary buttons “LINE” and “CIRCLE,” once selected, reposition the nodes in different locations, which may be more visually appealing to the user. The exemplary buttons “ALL OFF” and “ALL ON,” once selected, hide or display, respectively, all of the TEST_TRANSITIONs. The exemplary buttons “SKIPS OFF” and “SKIPS ON,” once selected, hide or display, respectively, all of the TEST_TRANSITIONS that are not “optimal” (defined in this case as “passing and moving to the next defined test). When selected, the exemplary buttons “RET OFF” and “RET ON” hide or display, respectively, the TEST_RETEST items to remove visual clutter on the screen. Clicking the exemplary button “LPY” (“Last Pass Yield”) is similar to clicking “ALL OFF” and “RET OFF” buttons to show only the UNIQUE_DEVICEs' final locations. The exemplary button “Print” instructs the user interface, for example, a web browser, to print the currently viewable area(s).

FIG. 8 depicts an exemplary Test Flow with the first node (test) 802 fully displayed, according to some embodiments of the present invention. This instance illustrates all of the inputs and outputs for this node (test). Tests that FAIL and then are tested again at a different location pass along the lines 804 (e.g., 96 devices/tests went from “TEST_1” to “TEST_2”). If moving forward (to the right) and on a FAIL path (below the line and typically colored in red), then they probably indicate a bad scenario. The numbers inside the node (test) represent the “Works In Progress”. Given the range of data and test listing, 417 devices passed and 153 devices failed at “TEST_1” test and then had no more information—their “end” positions.

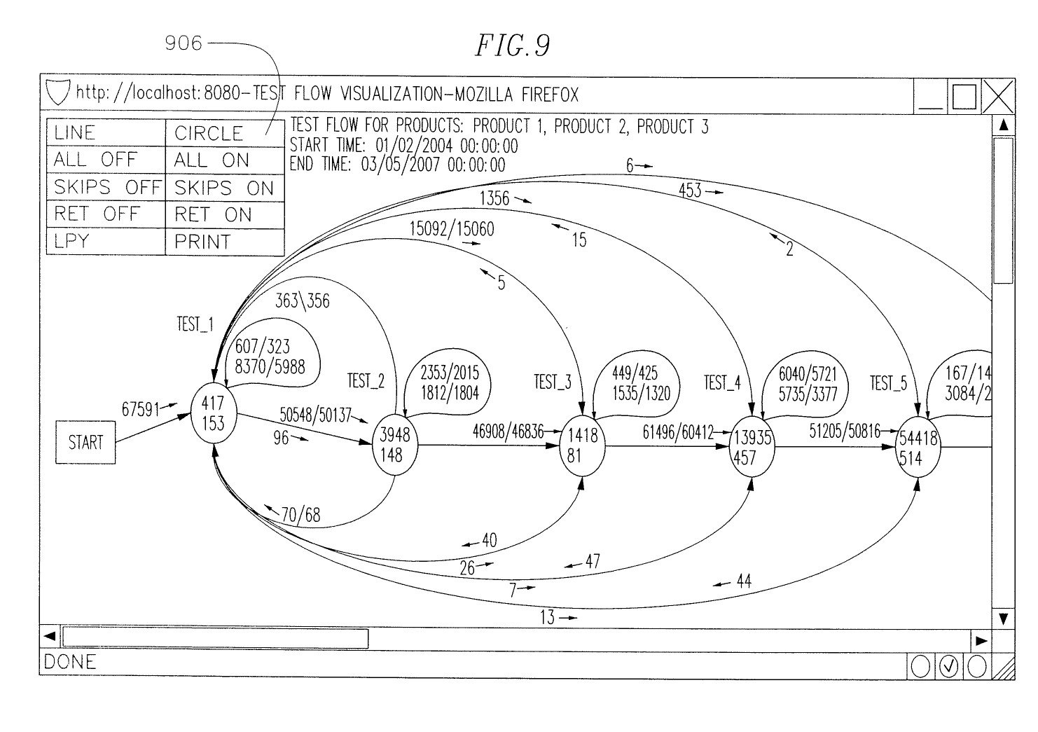

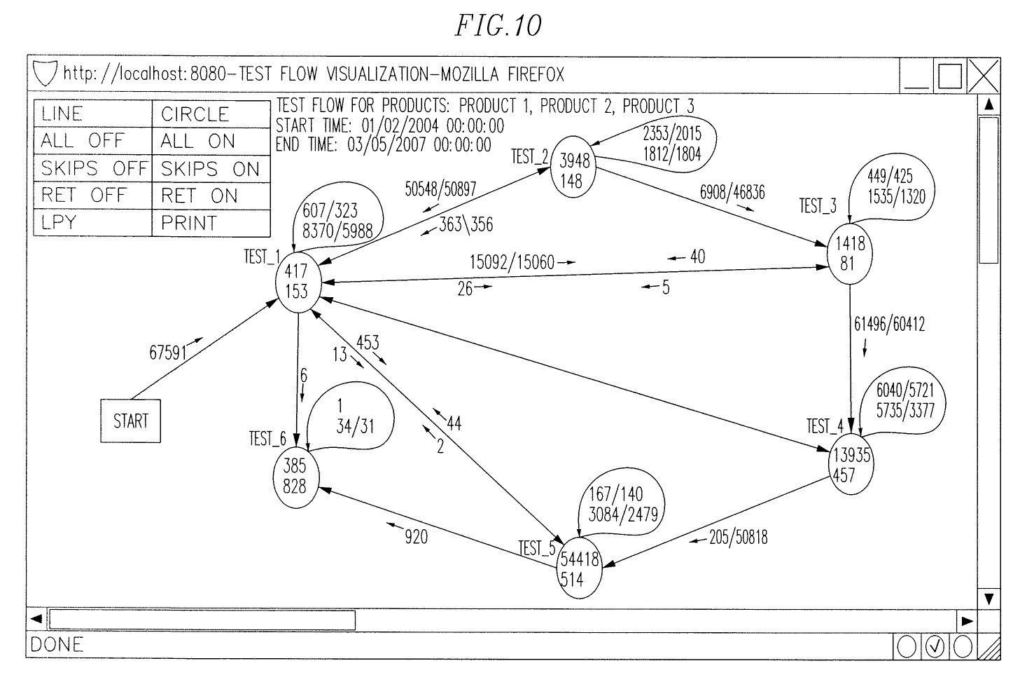

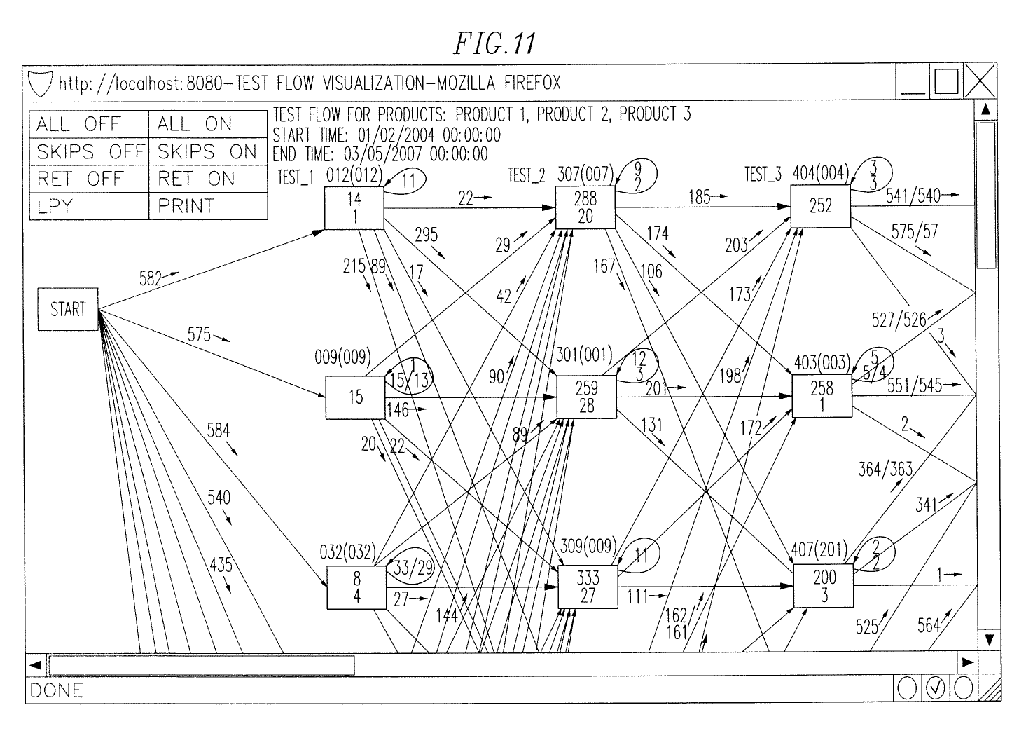

FIG. 9 illustrates an exemplary dynamic repositioning of the nodes, according to some embodiments of the present invention. In one embodiment, this is done via Javascript in a SVG document on the client side. However, the dynamic repositioning of the nodes may be accomplished using other known techniques, such as Flash. Pressing the CIRCLE button 906 reveals the screen shown in FIG. 10.

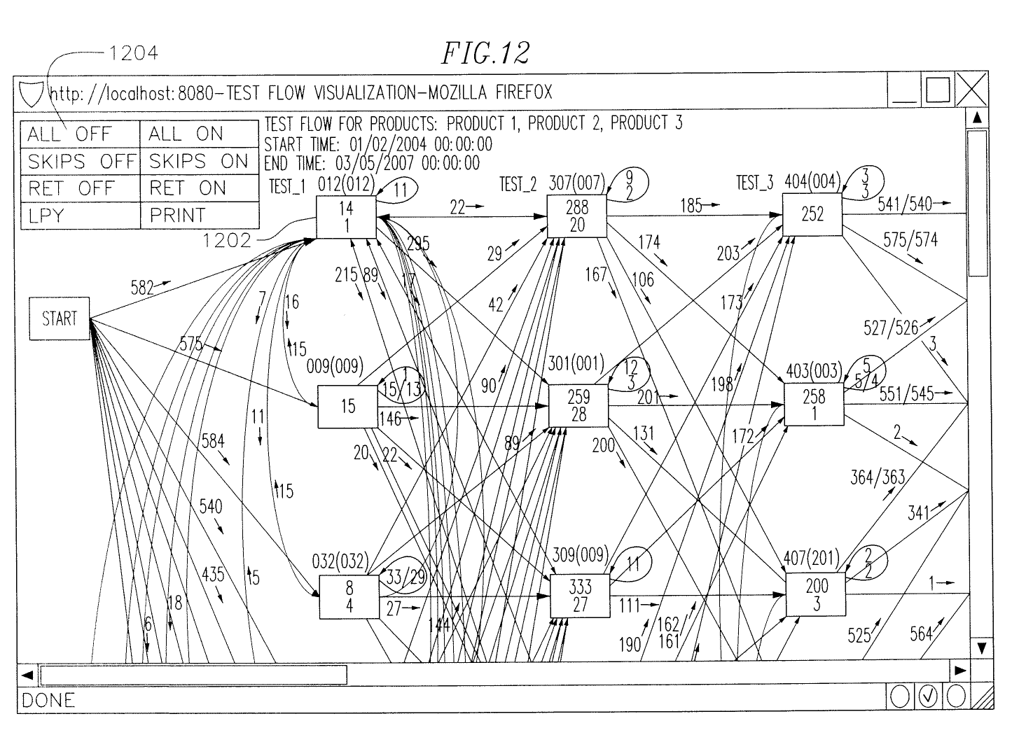

FIG. 10 depicts an exemplary “Circle” display view, according to some embodiments of the present invention. This view positions the objects (in this case, TEST_TESTs) in a (clockwise) circle. As shown, the first test still displays all the inputs and outputs. This view may be easier to work with depending on the data displayed. Objects are still dynamically repositionable and the arrows do not curve in this instance. Selecting “Test Flow by Station” from the configuration screen (not shown) takes the user to the test flow shown in FIG. 11.

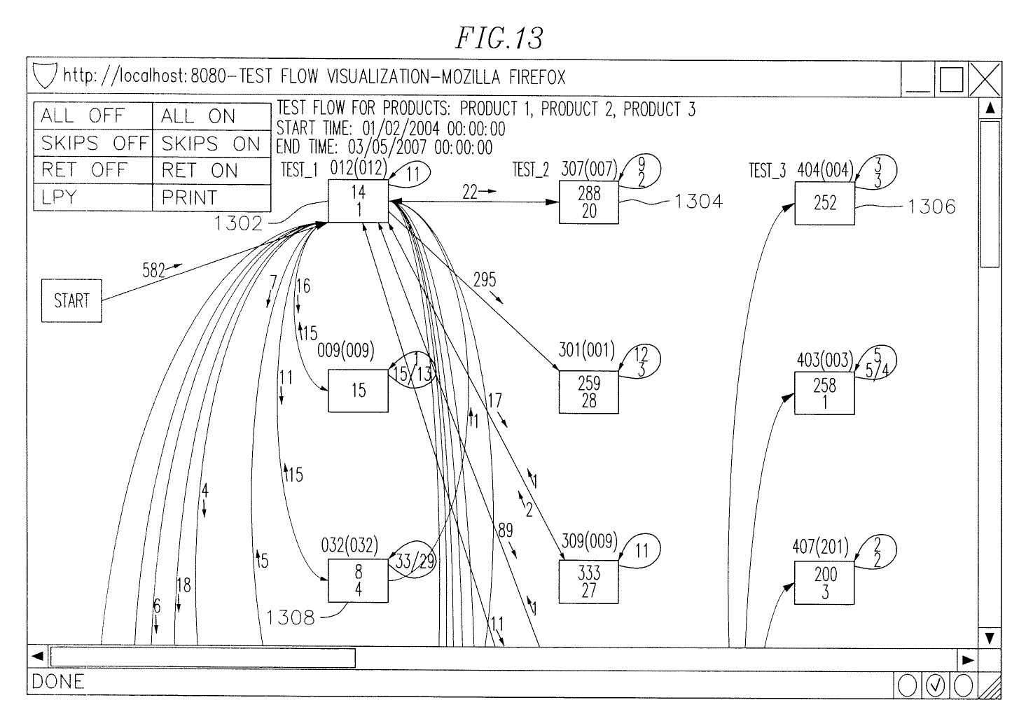

FIG. 11 shows an exemplary Test Flow by Station diagram, according to some embodiments of the present invention. As before, only the PASS to next test (optimal) paths are shown. Dynamic repositioning here is limited to vertical dragging of nodes (stations). This can be seen as an extension of the previous graph vertically into individual test stations, sorted by test. Moving the mouse to the first test station and double clicking shows all of that station's input and output, as depicted in the example of FIG. 12.

FIG. 12 illustrates an exemplary Test Flow by Station diagram with a first Station 1202 enabled, according to some embodiments of the present invention. The user can easily see any devices passed in between stations on the same test, which might indicate operators bringing a device to another station where parts may be more likely to pass. If the amount of information shown is cumbersome at this point, the user can click an “ALL OFF” button 1204 and then double-click on the first Station 1202 again to only show its paths, as depicted in FIG. 13.

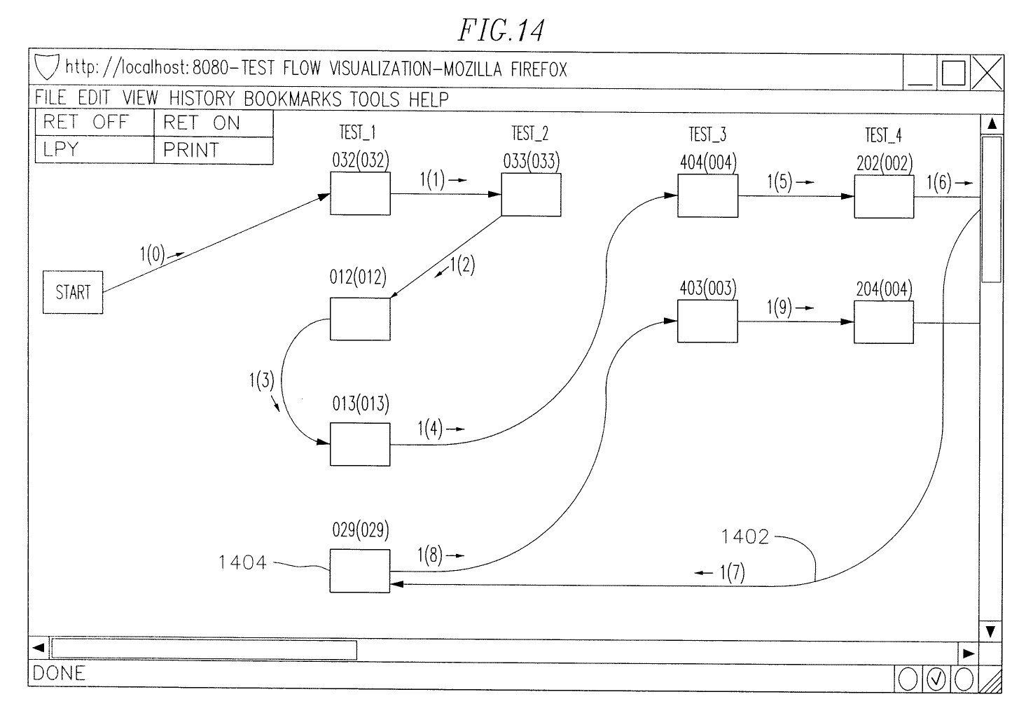

FIG. 13 shows an exemplary Test Flow by Station, only with first station 1302 information shown, according to some embodiments of the present invention. Here, the user can easily see that some number of devices are passing the “TEST_1” test 1302 and then skipping the “TEST_2” test 1304 to go directly to the “TEST_3” test 1306 from this station. This might indicate units that skipped a vital test. As shown, one the device from station “032” 1308 is passed and then was tested at station “012” 1302. For example, the fact that a device need to be tested again after passing, at a different station indicates bad operator practice. To investigate this single unit's Device Flow, the user can look at the exemplary diagram in FIG. 14, by selecting, for example, a specific entry point based on a specific serial number for a UNIQUE_DEVICE.

FIG. 14 depicts an exemplary Device Flow for a single unit, according to some embodiments of the present invention. Generally, the optimal flow for a device is test0, test1, test2, test3 (in most manufacturing processes). However, in this situation, this device seems to have been tested at four different test stations under the same test for some reason. After passing (indicated by having a green line) some later test at iteration 7 (1402), the device was then brought back to the first test 1404 for some reason. When the user (e.g., a manager) is presented with this information, they can make decisions and investigate the manufacturing process to make sure that unusual situations like this are minimized, thereby streamlining and optimizing the manufacturing throughput.

It will be recognized by those skilled in the art that various modifications may be made to the illustrated and other embodiments of the invention described above, without departing from the broad inventive scope thereof. It will be understood therefore that the invention is not limited to the particular embodiments or arrangements disclosed, but is rather intended to cover any changes, adaptations or modifications which are within the scope of the appended claims.

What is claimed is:

1. A method performed by one or more computers for processing and displaying time-based data, the method comprising:
storing manufacturing information including information about items, tests, test stations, and results of tests, in a database;
sorting the stored manufacturing information in chronological order;
tabulating a distance matrix with the sorted information, the distance matrix indexed by one or more of said items, said different tests, and said test stations; and
displaying on a display monitor the distance matrix as a graph comprising of a plurality of test steps depicted as a series of diagram nodes and including tests or test stations, test transitions between each test step depicted as a series of arrows and including values for respective test transitions, test step descriptions corresponding to each respective test step, and test results corresponding to said each respective test step.

2. The method of claim 1, further comprising incrementing the values in the tabulated distance matrix to indicate passing of an item through a test step.

3. The method of claim 1, wherein said values for respective test transitions include one or more of the group consisting of count of test steps having a certain test result, count of all test steps, count of items with said certain test result, count of all items, and percentage of items having said certain test result relative to items not having said certain test result.

4. The method of claim 1, wherein said values for respective test transition include one or more of the group consisting of a first-pass-yield indicating a first test result of an item at a test step, and time between tests.

5. The method of claim 1, wherein each of said test steps includes one or more of the group consisting of a test type, location of a test station, an test station type.

6. The method of claim 1, wherein said test steps depicted as a series of diagram nodes are displayed horizontally across said display monitor.

7. The method of claim 1, wherein said test steps represent test stations only and are depicted as a series of diagram nodes are displayed vertically across said display monitor.

8. The method of claim 1, wherein each of said test steps represent a test containing all information related to said test type.

9. The method of claim 1, wherein each of said test steps represent a single physical test station showing the items flowing in and out of the test station as the items being tested.

10. The method of claim 1, wherein said displayed test results include pass or fail.

11. The method of claim 1, further comprising depicting repair results for the items corresponding to respective test steps.

12. The method of claim 1, further comprising dynamically repositioning one or more of said displayed series of diagram nodes including the information associated with said one or more of said displayed series of diagram nodes.

13. The method of claim 1, further comprising filtering selected data to prevent display of said selected data.
